(19) United States
(12) Patent Application Publication
(10) Pub. No.: US 2008/0294839 A1
(43) Pub. Date: Nov. 27, 2008

(54) System and method for dumping memory in computer systems

(76) Inventors: Michael I. Bell, Glen Mills, PA (US); James W. Thompson, West Chester, PA (US)

Correspondence Address: UNISYS CORPORATION, UNISYS WAY, MAIL STATION: E8-114, BLUE BELL, PA, 19424, US

(21) Appl. No.: 10/942,466

(22) Filed: Sep. 16, 2004

Related U.S. Application Data
(60) Provisional application No. 60/557,216, filed on Mar. 29, 2004.

(51) Int. Cl. G06F 13/00; G06F 12/00; G06F 12/02

(52) U.S. Cl. 711/104; 711/111; 711/112; 711/173; 711/165; 711/E12.001; 711/E12.002

(57) ABSTRACT

A method and system for dumping computer memory includes receiving an instruction to perform a dump of memory in a partitioned computer system where each partition has at least one processor and associated memory. The associated memory having a first portion and a second portion where the first portion is normally actively used for user application program or data storage. After receipt of the dump request, the source memory content is protected against corruption or contention from other program sources and copied into the second portion of memory. Preferably, the first and second portions are co-located RAM to provide speedy transfers of information. Access to the first portion of memory is then permitted by removing the protections and the user may have full access to run applications. The dump image is then transferred to any location as a background I/O task as the user executes his applications.

### REFERENCE TO RELATED APPLICATIONS

This application claims priority from provisional U.S. application Ser. No. 60/557,216.

The following co-pending application has subject matter in common with the current application:

Patent application Ser. No. 09/676,162 filed Sep. 29, 2000 entitled “Authorization Key System for Selectively Controlling the Performance of a Data Processing System”, attorney docket number RA-5311, which is incorporated herein in its entirety.

### FIELD OF THE INVENTION

The current invention relates generally to data processing systems, and more particularly to methods for dumping the memory of a computer system

### BACKGROUND OF THE INVENTION

One common program maintenance tool for computer systems is the memory dump. A memory dump may be defined as the acquisition of the contents of memory for display, printout, diagnostic or storage purposes. When an application program fails in some manner, a memory dump can be taken in order to examine the status of the program at the time of the crash. The programmer looks into the buffers to see which data items were being worked on when it failed. Counters, variables, switches and flags may also be inspected along with the contents of program and data memory. During a standard memory dump, the active application programs of the computer may be suspended so that the contents of program and data memory may be transferred to a hard disk or other storage media such as tape or optical storage. Often, this process can suspend useful computer application operations for a significant length of time while active program or data memory is copied from its source to a target storage area. This loss of availability of the computer memory can be costly because of the loss of normal computer application productivity.

Some prior art advances have addressed this seemingly needless down time by implementing faster transfer mechanisms. But, these advances can be offset as active memory grows in size in proportion to application complexity and code size. Other solutions include time slicing the memory dump operation by alternately stopping operations, transferring a portion of memory, then restarting operations, and stopping them again for another partial transfer. This approach accepts a slower overall throughput for both the computer application operation and the dump in order to avoid a large block of contiguous downtime. However, in modern applications, either a large contiguous downtime or a reduced overall performance to conduct a memory dump can be unacceptable.

Thus, there is a need for a mechanism in a computer system to provide a more efficient method of conducting a dump of memory. The present invention addresses the aforementioned need and addresses it with additional advantages as expressed herein.

### SUMMARY OF THE INVENTION

A method of dumping computer memory is described which includes receiving an instruction to perform a dump of memory of a partitioned computer system. The computer system has partitions which have at least one processor and associated memory. A first portion of memory has a memory content that is normally accessible by an active partition which performs the users applications. A second portion of memory is available for temporary dump storage. The dump procedure prevents access to the memory content from a source other than a dump related operation in order to preclude memory corruption or contention problems during the dump process. Thus all active threads are suspended when a dump operation starts, and resumed when the dump operation completes. The source memory content is quickly copied from the first portion of memory to the second portion of memory, and after this, the formerly active threads may be reactivated. The first and second portions of memory are preferably RAM and being in the same local addressing area facilitating swift memory to memory transfers. The dump process then releases the contention restraints placed on the memory and allows access to the memory content of the first portion by a user application. Thereafter, the dump process may transfer the dump image in the second portion of memory out of the computer partition at any I/O speed while the partition continues to execute the users applications. The final destination of the dump image data may be a magnetic or optical disk, tape, or printed media.

In alternate embodiments, the computer partition has multiple processors and each contribute to the copying step by each copying a portion of the source memory content simultaneously, thus reducing copy time from the first portion or active program area of memory to the second portion or dump space of memory.

### BRIEF DESCRIPTION OF THE DRAWINGS

The foregoing summary, as well as the following detailed description of exemplary embodiments, is better understood when read in conjunction with the appended drawings. For the purpose of illustrating the invention, there is shown in the drawings exemplary constructions of the invention; however, the invention is not limited to the specific methods and instrumentalities disclosed. In the drawings:

FIG. 1 is a block diagram of an exemplary system that may employ the current invention;

FIG. 2 is a block diagram addressing a memory allocation in an exemplary computing environment;

FIG. 3 is a flow diagram addressing a memory dump aspect employed in an embodiment of the invention.

### DETAILED DESCRIPTION OF ILLUSTRATIVE EMBODIMENTS

One approach to the problem of conducting memory dumps that does not grossly impact the availability of the computer system is to have the dump occur simultaneously with the normal application operations. Generally, this approach has been precluded because of contention for access to the memory by the dump operation and the application operation. Also, the possibility that the memory to be dumped may be changed via computer application operation has also inhibited the simultaneous dump and application operation approach. However, in one embodiment of the present invention, that of a partitioned computer system wherein memory licensing is employed, the resources needed to perform a near simultaneous dump and application operation are readily available.

A partitioned computer system may be established as a result of a contract for computer services between a business user and a computer supplier. A partition is a grouping of resources that are allocated to execute in a cooperative manner to perform one or more assigned tasks. Each partition determined in the contract may specify an instruction processor (IP) performance level so that a business user can apply the partition to computing tasks that his business needs to perform.

For example, a partition may be formed that includes one or more predetermined instruction processors (IOPs) and Input/Output Processors (IOPs), and a predetermined amount of memory within a shared main memory. A second partition may be created to include different processors, IPs and IOPs, and another memory range. Each of these partitions may operate independently from the other, each partition having its own operating system, so that a number of tasks may be executed in parallel within the system.

Just as additional processors may be employed to adapt to a changing business requirement by engaging additional processors, so too can memory be expanded and licensed in a partition. In one implementation, described herein, a memory key may be used to license a portion of the available memory in a system. Using such a system, a user can use the licensed portion of memory to run applications but the unlicensed portion of memory may go unused because the user has not acquired a memory key to unlock those resources. Yet, in this environment, it may be desirable for a system manufacturer to provide indirect use of the unlicensed memory resource to provide a higher availability of the system for the user. Thus, in the environment of a partitioned computer system, a manufacturer may provide the means for one embodiment of a solution to the availability problem that a large memory dump imposes on a user. Although a partitioned computer environment is not strictly needed to implement the current invention, the partitioned computer environment does serve to exemplify some of the aspects of the invention.

### Partitioned Computer Environment

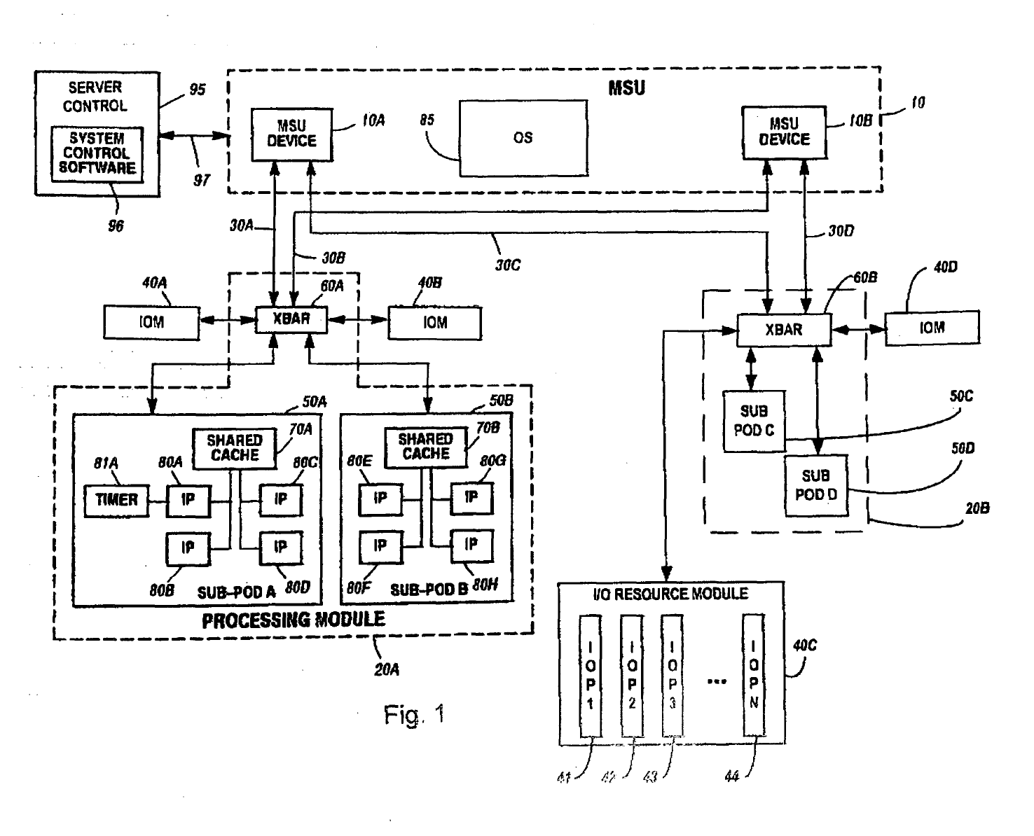

FIG. 1 is a block diagram of an exemplary partitioned computer system that may employ the current invention. This partitioned computer system includes a Memory Storage Unit (MSU) 10 (shown dashed) which provides the main memory facility for the system. The MSU includes one or more MSU devices individually shown as MSU 10A and MSU 10B, which each contains a predetermined portion of the memory space of the system. Many more MSU devices may be included within a full configuration.

The system further includes processing modules (PODs) 20A and 20B. A POD provides the processing capability for partitions within the computer system A greater or lesser number of PODs may be included in the system than are shown in FIG. 1. In one embodiment, up to four PODs are included in a fully populated system.

Each of the PODs is coupled to each of the MSU devices via a dedicated, point-to-point connection referred to as an MSU Interface (MI), individually shown as MIs 30A through 30D. For example, MI 30A interfaces POD 20A to MSU device 10A, and MI 30B interfaces POD 20A to MSU 10B device. Other MI units are similarly interfaced to other PODs.

Each POD includes two sub-processing modules (Sub-PODs) and a crossbar module (XBAR). For example, POD 20A includes sub-PODs 50A and 50B and XBAR 60A. Other PODS and XBARS are similarly configured. Each sub-POD is interconnected to the respective crossbar module (XBAR) through a dedicated point-to-point interface.

The system of FIG. 1 may further include input/output resource modules (IOMs) individually shown as IOMs 40A through 40D. The input/output modules provide the interface between various communications links and a respective one of the PODs 20. Each IOM is coupled to a POD via the POD's XBAR. For example, I/O 40A is coupled to XBAR 60A. XBAR 60A buffers data for the respective sub-PODs 50A and 50B and IOM 40A and 40B and functions as a switch to route data between any of these sub-PODs and IOMs to an addressed one of the MSU devices 10A and 10B. The input/output resource modules 40A, B and C contain input/output processors (IOPs) 41, 42, 43 and 44. Each IOP preferably contains multiple I/O channels, each channel being capable of transfer rate control via the local IOP.

In the exemplary system of FIG. 1, each sub-POD includes a shared cache and one or more Instruction Processors (IPs). For example, sub-POD 50A includes shared cache 70A and IPs 80A-80D. Other sub-PODs are similarly configured. In one embodiment, a sub-POD 50 may include between one and four IPs 80. Each IP may include one or more dedicated caches and interface logic for coupling to the interface with the shared cache. The shared cache stores data for each of the IPs within its sub-POD. Finally, each IP includes a quantum timer shown as timer 81A for IP 80A. This timer has many uses, including the facilitation of multi-tasking for the respective IP.

The system of FIG. 1 includes at least one instance of an Operating System (OS) that

loaded into MSU 10 to control the system. OS 85 is shown generally occupying memory included within MSU 10, and it will be understood the selected memory range in which OS 85 resides will actually be provided by one of MSU devices 10A or 10B.

Finally, the system of FIG. 1 includes a system server 95, which may be a workstation, personal computer, or some other processing system executing system control software 96. This system server 95 is coupled to the other units in the system via a scan interface 97. Although for simplicity, the scan interface is shown coupled solely to MSU 10, it will be understood it is coupled to the other units in the system as well. System server 95 provides all initialization, maintenance, and recovery operations for the system via the scan interface. In addition, system server 95 may be employed by an operator to perform configuration activities.

The architecture of FIG. 1 may be utilized to construct a system of multiple partitions within a data processing system. It will be appreciated that the system of FIG. 1 is provided as an example computing environment in which the present invention may operate. Any other data processing system having any other type of configuration may usefully employ the inventive system and method to be discussed in the following paragraphs. With the foregoing available for discussion purposes, the current invention is described in regards to the remaining drawings.

### Processor and Memory Keys

A partition is a grouping of resources that are allocated to execute in a cooperative manner to perform one or more assigned tasks. A partitioned computer system provides that each partition has processor, memory and I/O resources. The system manufacturer provides one or more keys to the system user so that specific partition resources are made available to the system user. For example, computing performance in partitioned computer systems may be determined by the use of a processor key. A processor key enables functionality within a partition and may establish processor performance limits within the partition. Generally, there may be one processor key per established partition. The processor key for the partition defines baseline and ceiling processor performance parameters, expiration date and a maximum time of use for the identified partition.

A processor key may be modified to indicate that an memory key is needed to establish memory licensing for a given partition. For example, a processor key may have an indicator bit which informs the partitioned computer system that a memory licensing key is needed in the system to establish memory licensing. Patent application Ser. No. 09/676,162 entitled “Authorization Key System for Selectively Controlling the Performance of a Data Processing System” describes processor keying in detail.

Since a processor key may be read first in a partitioned computer system, the processor key can provide the first indication to a computer system that an memory key is needed to authorize the use of memory resources. In this instance, the processor key is examined by a software support module (IP1SUPPORT) running on an instruction processor (IP) in association with an operating system. The memory software support module is a program that contains an object library that manages licensing aspects of the present invention. An example operating system is the Master Control Program (MCP) available from Unisys® Corporation.

In one embodiment, a memory key may be an encrypted field that is input to the system control software 96 of FIG. 1 for key installation. The system licensing support software (IP1SUPPORT) may then decrypt the memory key such that an internal or decrypted format of the external memory key results.

The internal format of a memory key encodes the following data in 256 bits as shown in Table 1:

TABLE 1
Memory Key

| Data | Description or Value | Bits |
|---|---|---|
| Key Type | Permanent memory key = 3 | 4 |
| | Temporary memory key = 4 | |
| Version | =1 | 4 |
| | <Reserved> | 4 |
| MCN | Manufacturing Control Number (unique for each | 20 |
| | system) | |
| Days | Number of days a temporary key can be active | 10 |
| | <Reserved> | 18 |
| | <Available> | 4 |
| Expiration | Permanent key: = 0 | 16 |
| | Temporary key: Posix time format DIV (60*60*24) | |
| Machine ID | 8-bit machine type and 8-bit name ID | 16 |
| Key ID | Key creation timestamp in Posix time format | 32 |
| Memory | System-wide limit in MW | 32 |
| Size | | |
| | <Reserved> | 96 |

Note:
Posix time format refers to the number of seconds since midnight Jan. 1, 1970.

The key type field may be permanent or temporary. Generally, a permanent key has no expiration date whereas a temporary key may have a finite expiration date. Expiration time may be expressed in Posix time format refers to the number of seconds since midnight Jan. 1, 1970. The memory key may indicate the manufacturing control number (MCN) as well as a machine ID to identify the specific computer system the key was encoded to service. The number of days that a temporary key may be active as well as a key ID are also encoded. The memory size field of the Table 1 memory key specifies the system wide memory limit in mega words.

### Memory Dump

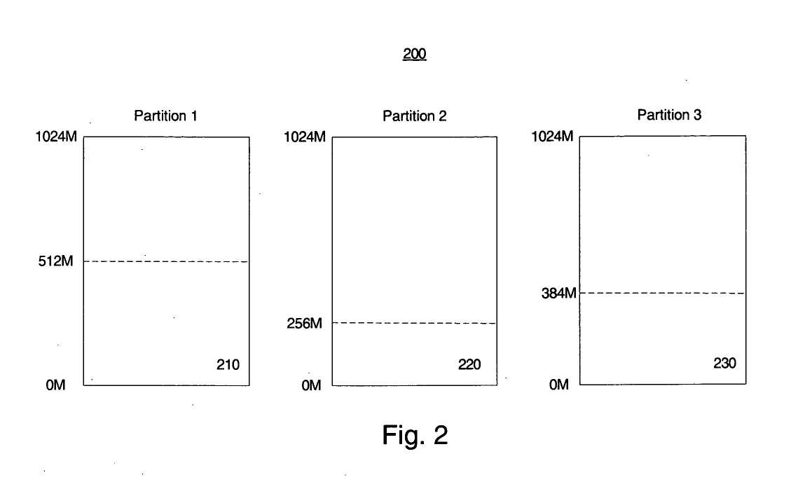

In one embodiment of the invention, a memory dump may be performed using memory that is present in a partition but not actively licensed. FIG. 2 depicts the memory allocation of a three partition computer system in which each partition owns 1024 M words, however, a memory key has only authorized use of 1152 M words system-wide. The allocation has been distributed as 512 M words in partition 1 (210), 256 M words in partition 2 (220), and 384 M words in partition 3 (230). The allocation of the system-wide memory limit across the three partitions may have been performed via a user interface or via a distribution scheme using the memory key. In either event, each partition shown in FIG. 2 may use the memory dump aspect of the present invention.

In the example of FIG. 2, partition 1 uses the lower space in memory from address 0 to 512 M words as active memory space (210). This is the memory licensed for use by the system-wide memory key. The memory space from 512 M words to 1024 M words of partition 1 may be used for fast memory dump, as that area is not licensed as available for direct user purposes via the memory license key. Note that the upper, unlicensed area of memory space in partition 1 is at least as large as the lower, licensed area of memory space. Partition 2 uses the lower space in memory from address 0 to 256 M words as active licensed memory space (220). The memory space from 256 M words to 1024 M words of partition 2 may be used for fast memory dump, as that area is not licensed. Likewise, the licensed memory space for partition 3 is address 0 to 384 M words (230). The unlicensed area from 384 M words to 1024 M words is available for fast memory dump. In FIG. 2, it should be noted that the memory space assigned to each partition is a logical address range that maps to a unique physical address range in the MSU of FIG. 1.

In the example of FIG. 2 and according to an aspect of the invention, a memory dump request for partition 1 would result in a temporary suspension of user application activity. This activity suspension may be a halt of the user application in partition 1 and a masking of interrupts that may access the active licensed area of partition 1. This temporary suspension is needed to preserve the memory contents of partition 1 so that a memory to memory transfer may be made within partition 1. The lower, actively licensed memory space is quickly copied to the upper, unlicensed area of memory so that both upper and lower portions contain the same memory information.

According to an aspect of the invention, the partition may then release the suspension of usher activities in partition 1 and allow the partition to return to user availability. The upper portion of memory of partition 1 then has the dump image of the memory contents of the licensed memory space. The upper portion of memory of partition 1 can then be transferred to any target location desired by the user or defined by the system. For example, the system or user may send the dump image contents of partition 1 to an external disk or tape drive via an I/O channel of the computer system. This may be performed as part of the main executive portion of a program running in the licensed portion of partition 1 or advantageously as a background task of either a user program or the operating system Note that this I/O transfer may take some time depending on the size of the transfer and the rate of I/O transfer but it does not affect the availability of the computer for user purposes. The user is able to run her application concurrently with a transfer of the dump image to storage and thus avoid unnecessary downtime.

In the example of FIG. 2, each computer partition may use the unlicensed memory space as temporary dump storage space. Each partition may be operated independently by its own operating system and applications, such that the dumps from each partition can occur asynchronously. Alternatively, the partitions may perform dumps roughly simultaneously if so provided by synchronizing activities in the three partitions to accommodate this.

It can well be understood by those of skill in the art, that the present invention need not require the use of a partitioned computer system as in the above example. However, the additional unlicensed local memory that is available in a partitioned memory licensed computer is a likely candidate environment for practicing the current invention. As a result, a generalized method for the invention may be discussed.

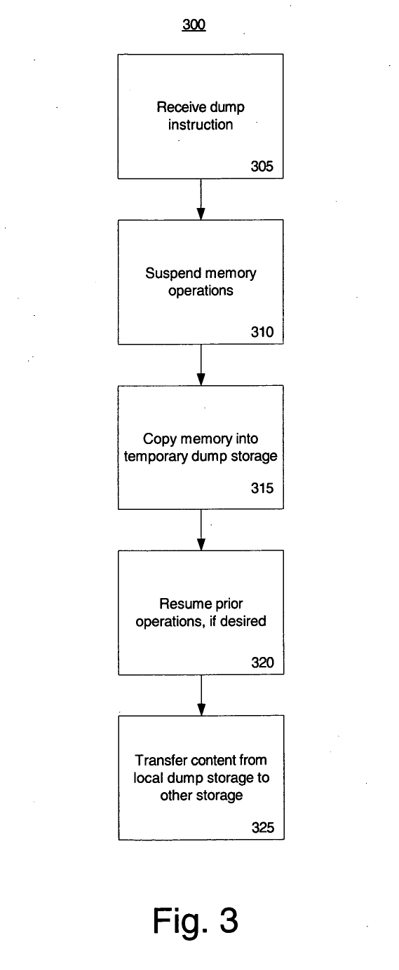

FIG. 3 is a flow diagram depicting a method 300 of the invention. The method may begin by receiving a dump instruction (step 305). The request for a memory dump normally specifies a range in memory to be dumped. The instruction may be received by via a user interface input or as a program input. The user input may be either a real-time or near real-time instruction to a computer. Alternately, the instruction may be received by the computer as part of a program that is executing within the computer. In either event, a response to the instruction is to suspend user-related operations in the memory selected to be dumped (step 310). This step represents an effort to prevent changes in important memory content that may result if another program gained control of the memory to be dumped. Such a program may be an application program or an interrupt from another program or hardware component of the computer. Step 310 is also performed to avoid contention for the memory to be dumped so that the memory is available for the dump operation according to the invention. It would be advisable to suspend housekeeping functions of the operating system for the partition and other maintenance or support processes and related threads as those of ordinary skill in this art will understand.

In one embodiment where there are multiple instruction processors in a partitioned computer system, receipt of the request may be followed by the computer partition entering a dump boot strap routine. This routine initializes the dump state, sets up the dump process parameters such as source and target start and end points, masks I/O interrupts, and waits for other processors to check in to report their readiness to continue with the dump process.

After the memory has been rendered quiescent and stable, the memory to be dumped is copied from one portion of memory to another portion of memory (step 315). In order to achieve a speed advantage, this memory to memory copy is preferably performed within local memory. In this manner, the transfer of information from the source or user area of memory to the dump are of memory is completed in a very time efficient manner. For example, if the user area to be dumped is co-located with the temporary dump area, then the transfer can be accomplished very efficiently without the latency involved in I/O transfers. An example of this type of environment was given in FIG. 2 where the transfer was performed between a lower portion of memory and an upper portion of memory within the same partition. Preferably, this transfer is performed within the same easily addressable, fast access RAM area.

It should be noted that this technique can produce a complete, non-compressed dump image. And eliminates the need for dump-to-disk (DN) files, which can span several disk units. However, an optional embodiment permits the use of compression. This approach may be advantageous in the situation where the memory space available for temporary dump storage is less than the size of the source content area. In this situation, a local memory compression scheme is preferable to a slower I/O based scheme. In one embodiment, a fast software or hardware compression mechanism that works with the local memory source and dump area may be preferable.

In one embodiment where there are multiple instruction processors in a partitioned computer system, each instruction processor may be tasked to take a corresponding area in memory and transfer the content of this area to the temporary dump memory. These transfers can occur simultaneously or nearly so as to gain a time advantage. This allows multiple processors to act as simultaneously as possible to transfer the specified source content of memory to the dump area of memory. This has the advantageous effect of performing the memory to memory transfer more quickly than if only one of several available processors were involved in the copy step.

Once an image of the memory space to be dumped is saved in local memory, then the user area of memory can be released to make it available to the user applications (step 320). This step allows the user to resume prior user operations if desired and is an aspect that provides value to the user by shortening the time that the user's computing resources are unavailable. The user can then advantageously utilize system resources for productive purposes while the dump image is available in dump memory which is not being used by normal user applications.

The memory dump image can then be transferred to any other location within the computer on a time-available basis (step 325). For example, if it is desired to transfer the dump image to disk or tape media via an I/O channel, the I/O transfer operation can be performed as a background task while the user has full access to his applications. This aspect allows a user to achieve the goal of transferring dump data to a storage, display, or presentation device without losing precious application runtime availability in the computer.

In the exemplary embodiment of a partitioned computer system with memory licensing, The fast memory dump completes in seconds rather than minutes. When a dump request occurs, the dumping processor enters a DUMPBOOTSTRAPPER routine and eventually a PRIMARYSETUP routine, where it initializes dump state, masks I/O interrupts, and waits for other processors to check in. At this point, if MEMCEILING, the maximum licensed area in a partition, is below the base address for a fast memory dump, and the fast dump area is not in use, PRIMARYSETUP calls procedure FASTDUMP.

FASTDUMP first stores header information in the FDUMPHDR (fast dump header) array which has the Table 2 format:

TABLE 2
Fast Dump Header Formats

| Word | Description |
|---|---|
| 0 | 8 ‘MD13 ‘ (indicates non-compressed) |
| 1 | MCPLEVEL |
| 2 | MDDATE |
| 3 | MDTIME |
| 4 | P1 |
| 5 | P2 |
| 6 | P3 |
| 7 | MASK |
| 8 | DUMP_NO |
| 9 | MDRCW |
| 10 | Dumping PROCID |
| 11 | MTOD |
| 12 | D0SETTING |
| 13-15 | Unused |
| 16-63 | SNR and F for each PROCID |
| 64-125 | Unused |
| 126 | Fast dump elapsed time (seconds) |
| 127 | Control word (0 = area available, 1 = area) |

The control word in FDUMPHDR is set upon entry to FASTDUMP. While the control word is set, memory reconfiguration is prohibited, including changes to the memory ceiling. In one embodiment, the procedure FASTDUMP determines the base address of the dump area as follows:

FDUMPBASE=HLP_MAX_ADDR−FDUMPSIZE, where HLP_MAX_ADDR is the partition memory size, and FDUMPSIZE=(MEMMAX+MEMNOTINUSE) DIV 2; where MEMMAX is the licensed memory size for the partition and MEMNOTINUSE is the difference between the partition memory size and the licensed memory size. Note MEMMAX must be less than or equal to MEMNOTINUSE in order to use fast memory dump.

As mentioned above, while exemplary embodiments of the invention have been described in connection with various computing devices, the underlying concepts may be applied to any computing device or system in which it is desirable to implement a fast dump method. Thus, the methods and systems of the present invention may be applied to a variety of applications and devices. While exemplary programming languages, names and examples are chosen herein as representative of various choices, these languages, names and examples are not intended to be limiting. One of ordinary skill in the art will appreciate that there are numerous ways of providing object code that achieves the same, similar or equivalent systems and methods achieved by the invention.

As is apparent from the above, all or portions of the various systems, methods, and aspects of the present invention may be embodied in hardware, software, or a combination of both. When embodied in software, the methods and apparatus of the present invention, or certain aspects or portions thereof, may be embodied in the form of program code (i.e., instructions). This program code may be stored on a computer-readable medium, such as a magnetic, electrical, or optical storage medium, including without limitation a floppy diskette, CD-ROM, CD-RW, DVD-ROM, DVD-RAM, magnetic tape, flash memory, hard disk drive, or any other machine-readable storage medium, wherein, when the program code is loaded into and executed by a machine, such as a computer or server, the machine becomes an apparatus for practicing the invention. A computer on which the program code executes will generally include a processor, a storage medium readable by the processor (including volatile and non-volatile memory and/or storage elements), at least one input device, and at least one output device. The program code may be implemented in a high level procedural or object oriented programming language. Alternatively, the program code can be implemented in an assembly or machine language. In any case, the language may be a compiled or interpreted language.

While the present invention has been described in connection with the preferred embodiments of the various figures, it is to be understood that other similar embodiments may be used or modifications and additions may be made to the described embodiment for performing the same function of the present invention without deviating therefrom. Therefore, the invention should not be limited to any single embodiment, but rather should be construed in breadth and scope in accordance with the appended claims.

1. A method of dumping computer memory, the method comprising:
receiving an instruction to perform a dump of memory of an active computer partition in a partitioned computer system, each partition having at least one processor separate from a processor of another partition, each partition having associated memory, the associated memory comprising a first portion of memory and a second portion of memory within each partition, the first portion of memory having a memory content accessible by the at least one processor of the active partition;
preventing access to the memory content from a source other than a dump related operation;
copying the memory content from the first portion to the second portion whereby the memory content resides in both the first portion and the second portion, wherein the first portion is an actively licensed portion of memory and the second portion is a non-licensed portion of memory, wherein the licensed portion of memory is enabled via a software memory licensing key providing licensed authority to use memory resources of the first portion, the software memory licensing key referenced by a processor key provided for the active partition, the processor key defining processor performance limits in the active partition;
allowing access to the memory content of the first portion by a source other than the dump related operation; and
transferring a content of the second portion to a target storage area, wherein the transfer occurs during execution of a program running in the first portion of the active partition.

2. The method of claim 1, wherein receiving an instruction to perform a dump of memory comprises receiving the instruction wherein two or more processors in the active partition respond, and wherein each responding processor copies a sub-portion of the first portion of memory to the second portion of memory.

3. The method of claim 2, wherein each responding processor copies a sub-portion of the first portion of memory into the second portion simultaneously with one another.

4. The method of claim 1, wherein receiving an instruction to perform a dump of memory comprises receiving an instruction from one or more of a user input and a program.

5. (canceled)

6. (canceled)

7. The method of claim 1, wherein copying the memory content from the first portion to the second portion comprises compressing the memory content after reading the memory content from the first portion and before writing the memory content into the second portion.

8. The method of claim 1, wherein preventing access to the memory content comprises masking interrupts of a program operating with the associated memory.

9. The method of claim 1, wherein copying the memory content comprises performing a memory to memory copy of the memory content in RAM.

10. The method of claim 1, wherein allowing access to the memory content of the first portion comprises unmasking interrupts of a program operating with the first portion of memory.

11. The method of claim 1, wherein transferring a content of the second portion to a target area comprises copying the content of the second portion to at least one of a I/O port, a disk storage device and a tape storage device.

12. The method of claim 1, wherein transferring a content of the second portion to a target area comprises transferring the content of the second portion during the execution of a program running in the background of the active computer partition.

13. A computer system comprising:
at least one partition, each partition having at least one processor and associated memory; and
the associated memory comprising a first portion and a second portion within the same partition, wherein the first portion is used by a user-related operation, wherein the first portion is an actively licensed portion of memory and the second portion is a non-licensed portion of memory, wherein the licensed portion of memory is enabled via a software memory licensing key providing licensed authority to use memory resources of the first portion, the software memory licensing key referenced by a processor key provided for the at least one partition, the processor key defining processor performance limits in the at least one partition;
software instructions which, when executed, accomplish a functionality to dump the content of an active partition memory, the functionality comprising;
receiving an instruction to perform the dump of memory content;
preventing access to the active partition memory content by the user-related operation;
copying the memory content from the first portion to the second portion, whereby the memory content resides in both the first portion and the second portion;
allowing access to the memory content of the first portion by the user-related operation; and
transferring a content of the second portion of the active partition to a target device to dump the content of the active partition memory, wherein the transfer occurs during execution of the user-related operation running in the first portion of the active partition; and
a user interface which permits at least one of monitoring and control of the dump of the active partition memory.

14. The system of claim 13, wherein two or more processors in the active partition respond to receipt of an instruction to perform a dump of memory content, and wherein each responding processor copies a sub-portion of the first portion of memory to the second portion of memory.

15. The system of claim 13, wherein each responding processor copies a sub-portion of the first portion of memory into the second portion simultaneously with one another.

16. The system of claim 13, wherein the step of receiving an instruction to perform a dump of memory comprises receiving an instruction from one or more of the user interface and a program under execution.

17. (canceled)

18. (canceled)

19. The system of claim 13, wherein the step of copying the memory content comprises performing a memory to memory copy of the memory content in RAM.

20. The system of claim 13, wherein the target device is one of a I/O port, a disk storage device and a tape storage device.

21. A computer-readable medium having instructions therein, executable by a computer to perform a method of performing a dump of memory, the method comprising:
receiving an instruction to perform a dump of memory of an active computer partition in a partitioned computer system, each partition having at least one processor separate from a processor of another partition, each partition having associated memory, the associated memory comprising a first portion of memory and a second portion of memory within each partition, the first portion of memory having a memory content accessible by the at least one processor of the active partition, the first portion comprising an actively licensed portion of memory and the second portion comprising a non-licensed portion of memory, wherein the licensed portion of memory is enabled via a software memory licensing key providing licensed authority to use memory resources of the first portion, the software memory licensing key referenced by a processor key provided for the active partition, the processor key defining processor performance limits in the active partition;
preventing access to the memory content from a source other than a dump related operation;
copying the memory content from the first portion to the second portion, whereby the memory content resides in both the first portion and the second portion;
allowing access to the memory content of the first portion by a source other than the dump related operation; and
transferring a content of the second portion to a target storage area, wherein the transfer occurs during execution of a program running in the first portion of the active partition.

22. The computer-readable medium of claim 21, wherein the step of receiving an instruction to perform a dump of memory comprises receiving the instruction wherein two or more processors in the active partition respond, and wherein each responding processor copies a sub-portion of the first portion of memory to the second portion of memory.

23. (canceled)

24. (canceled)

25. The computer-readable medium of claim 22, wherein the step of copying the memory content from the first portion to the second portion comprises compressing the memory content after reading the memory content from the first portion and before writing the memory content into the second portion.

26. The computer-readable medium of claim 22, wherein the step of copying the memory content comprises performing a memory to memory copy of the memory content in RAM.

27. The computer-readable medium of claim 22, wherein the step of transferring a content of the second portion to a target area comprises copying the content of the second portion to at least one of a I/O port, a disk storage device and a tape storage device.
